(19) United States
(12) Patent Application Publication
(10) Pub. No.: US 2021/0201335 A1
(43) Pub. Date: Jul. 1, 2021

(54) CUSTOMER EXPERIENCE RATING SYSTEM AND METHOD

(71) Applicant: Aureus Tech Inc., Hartford, CT (US)

(72) Inventors: Nitin Purohit, Mumbai (IN); Ashish Tanna, Mumbai (IN); Anurag Shah, West Hartford, CT (US); Nilesh Naval Karnik, Maharashtra (IN)

(21) Appl. No.: 17/136,647

(22) Filed: Dec. 29, 2020

Related U.S. Application Data
(60) Provisional application No. 62/955,158, filed on Dec. 30, 2019.

(51) Int. Cl. G06Q 30/02; G06F 9/451

(52) U.S. Cl. CPC G06Q 30/0201; G06F 9/451

(57) ABSTRACT

The present disclosure generally relates to methods and systems for determining a customer experience score. The methods and systems are configured to receive customer interaction data indicative of customer interaction events with a service provider, receive weight configuration data indicative of a weight associated with the events in the customer interaction data, and calculate the customer experience score for each customer contained in the customer interaction data based on the events identified in the customer interaction data and the weight configuration data.

### CROSS-REFERENCE TO RELATED APPLICATION

This application claims the benefit of U.S. Provisional Patent Application No. 62/955,158 filed on Dec. 30, 2019, which is hereby incorporated by reference in its entirety, to the fullest extent permitted under applicable law.

### TECHNICAL FIELD

The present disclosure generally relates to customer experience rating systems, methods and devices and, more particularly, to customer experience rating systems, methods and devices for evaluating the experience of customers of insurance companies.

### BACKGROUND

Businesses have taken many different approaches in developing customer experience of customers. A business may utilize one or more different customer development programs in an effort to increase customer experience. The success of the customer development programs is not readily apparent or easy to gauge by the business. Sometimes a business may analyze various data available to the business in an effort to determine the experience of its customers, such as analyzing sales data or customer survey data. However, conventional methods and systems for obtaining customer experience are lacking in many aspects.

### BRIEF DESCRIPTION OF THE DRAWINGS

FIG. 1A is a diagram of a customer experience rating system in accordance with some embodiments of the present disclosure.

FIB. 1B is a diagram of the customer experience rating system of FIG. 1A operating in over a network environment in accordance with embodiments of the present disclosure.

FIG. 2 is a flow diagram of a customer experience rating method in accordance with embodiments of the present disclosure.

FIG. 3 shows a graphical user interface of a customer experience rating system in accordance with embodiments of the present disclosure.

FIG. 4A shows a graphical user interface of a customer experience rating system in accordance with embodiments of the present disclosure.

FIG. 4B shows a graphical user interface of a customer experience rating system in accordance with embodiments of the present disclosure.

FIG. 4C shows a graphical user interface of a customer experience rating system in accordance with embodiments of the present disclosure.

FIG. 4D shows a graphical user interface of a customer experience rating system in accordance with embodiments of the present disclosure.

FIG. 4E shows a graphical user interface of a customer experience rating system in accordance with embodiments of the present disclosure.

FIG. 4F shows a graphical user interface of a customer experience rating system in accordance with embodiments of the present disclosure.

FIG. 4G shows a graphical user interface of a customer experience rating system in accordance with embodiments of the present disclosure.

FIG. 4H shows a graphical user interface of a customer experience rating system in accordance with embodiments of the present disclosure.

FIG. 4I shows a graphical user interface of a customer experience rating system in accordance with embodiments of the present disclosure.

FIG. 4J shows a graphical user interface of a customer experience rating system in accordance with embodiments of the present disclosure.

FIG. 4K shows a graphical user interface of a customer experience rating system in accordance with embodiments of the present disclosure.

FIG. 4L shows a graphical user interface of a customer experience rating system in accordance with embodiments of the present disclosure.

FIG. 5A shows a weight configuration table in accordance with embodiments of the present disclosure.

FIG. 5B shows a flow diagram of a weight assignment logic in accordance with embodiments of the present disclosure.

FIG. 6 shows an output table of a customer experience rating system in accordance with embodiments of the present disclosure.

FIG. 7 shows a flow diagram for a customer experience action logic in accordance with embodiments of the present disclosure.

### DETAILED DESCRIPTION

As described further herein, the present disclosure advantageously provides methods and systems that determine a customer experience and/or a cumulative customer experience score for a customer (or user or consumer). Systems and methods according to the present disclosure allow for accurate customer experience of the user.

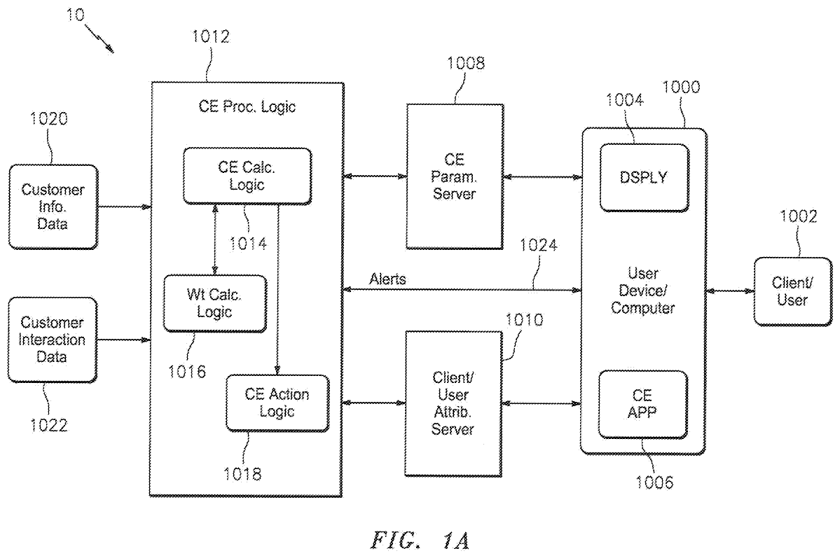

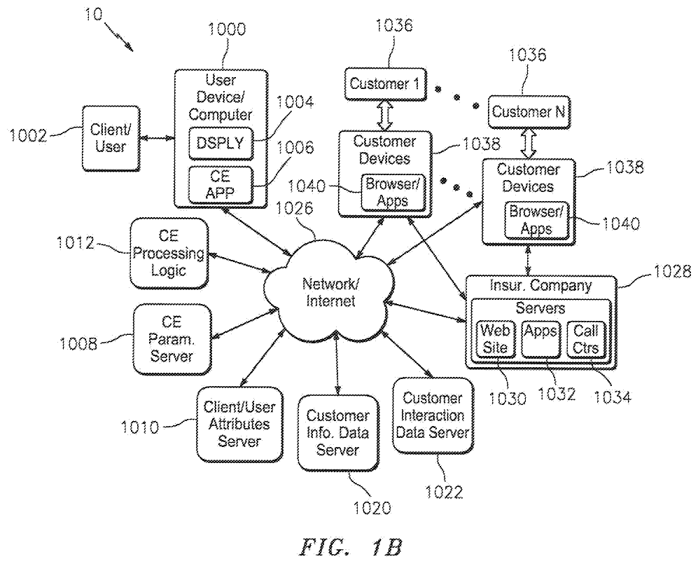

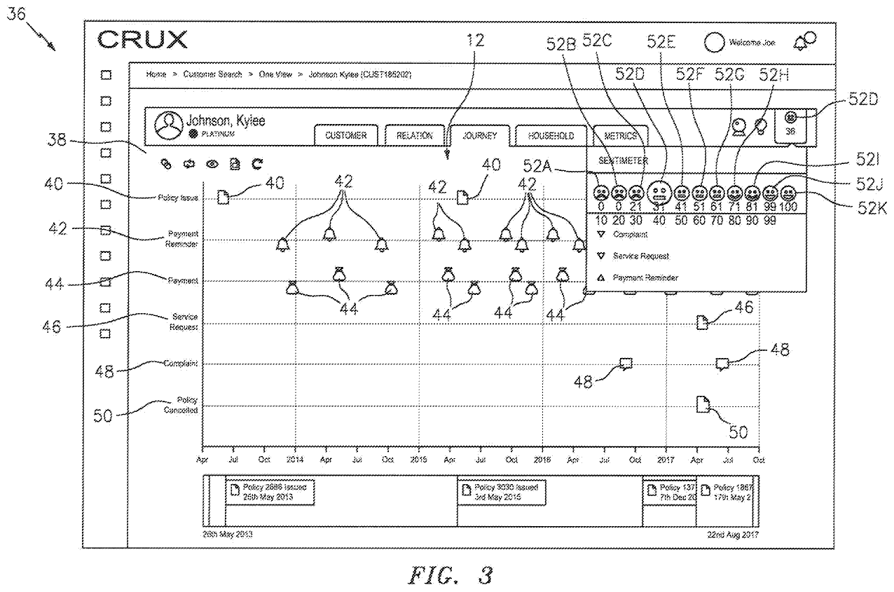

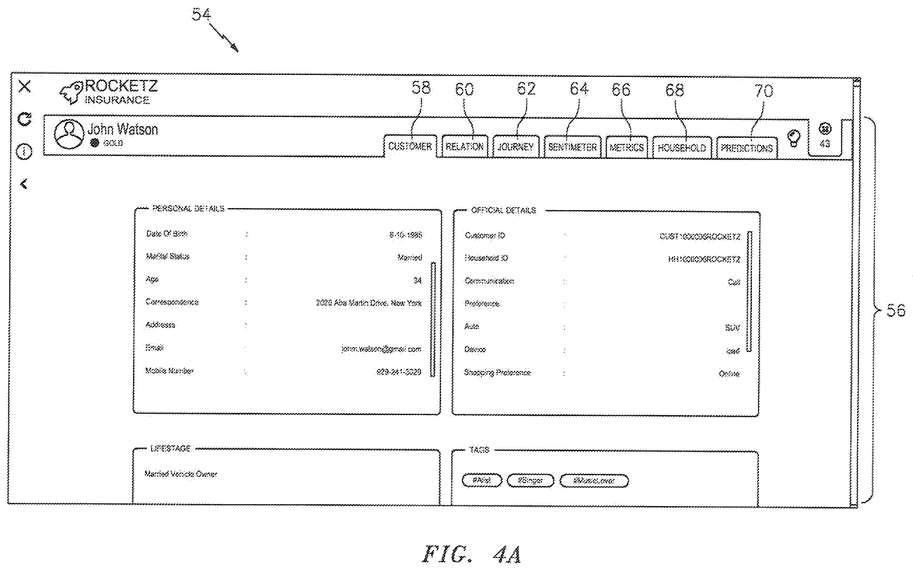

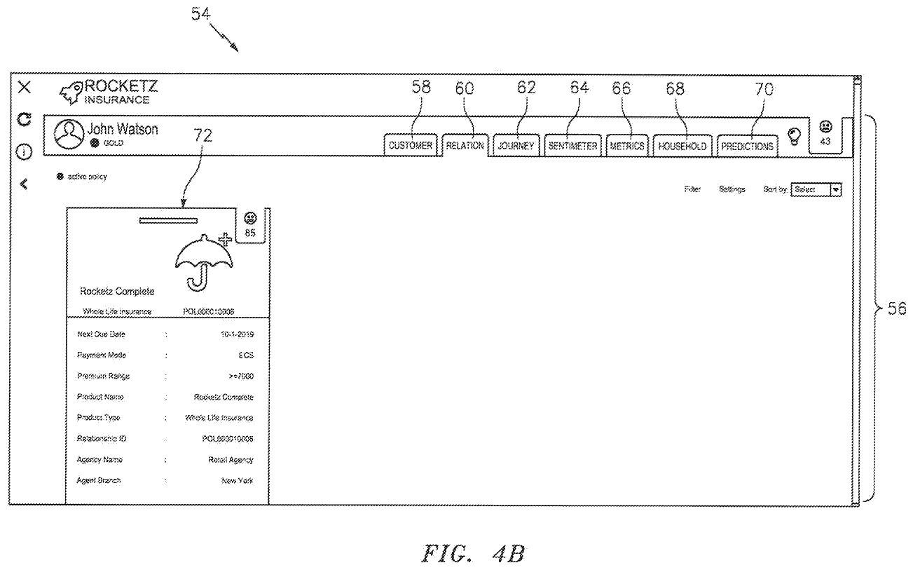

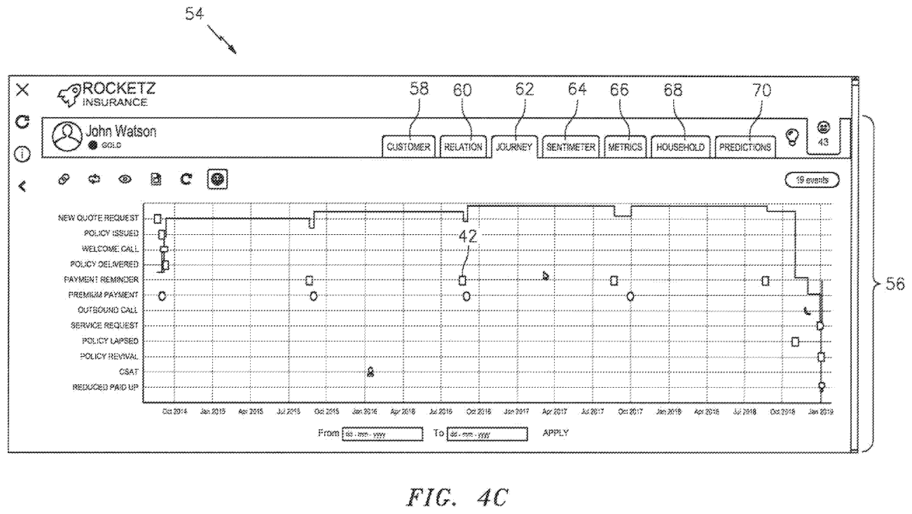

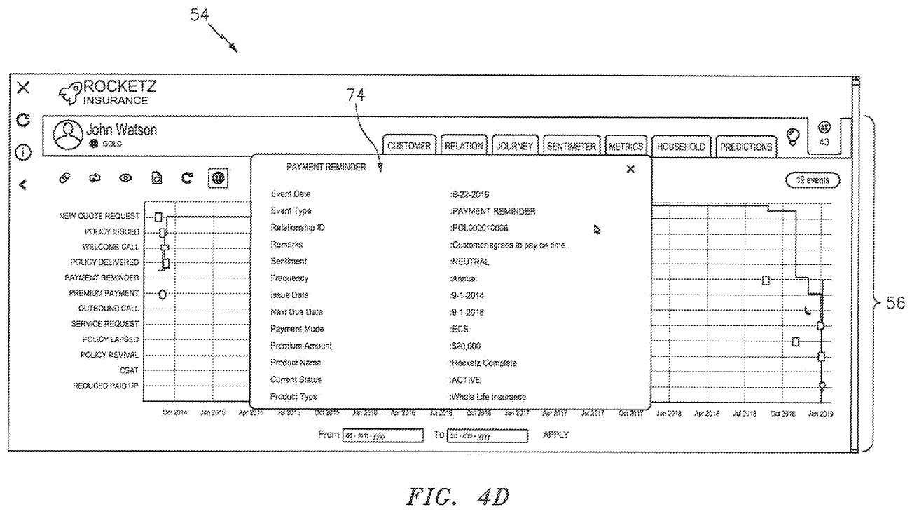

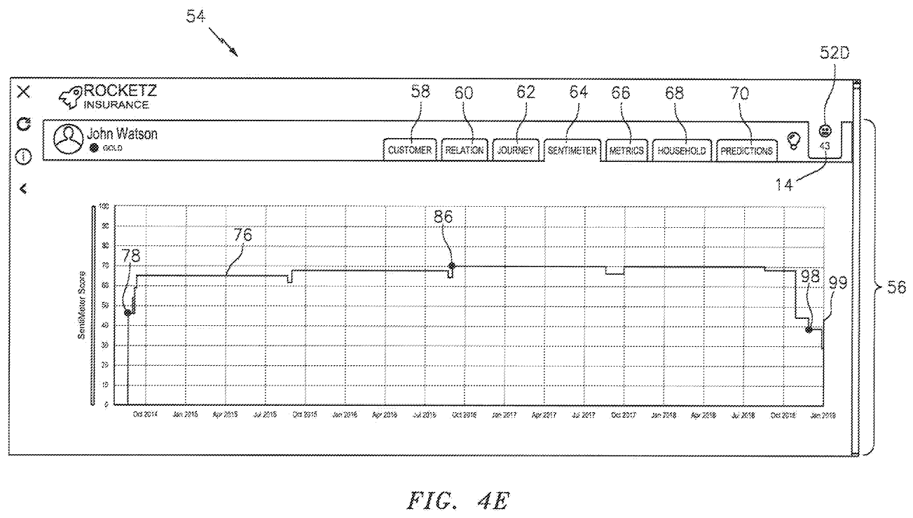

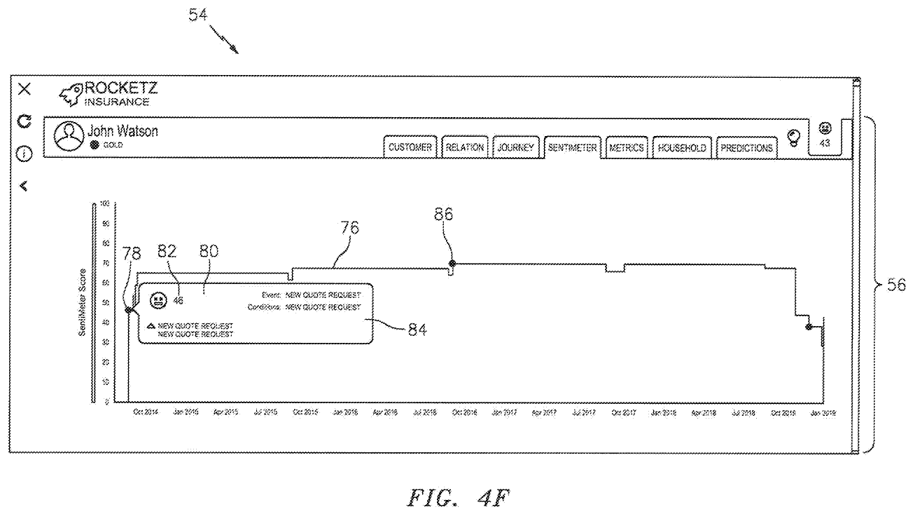

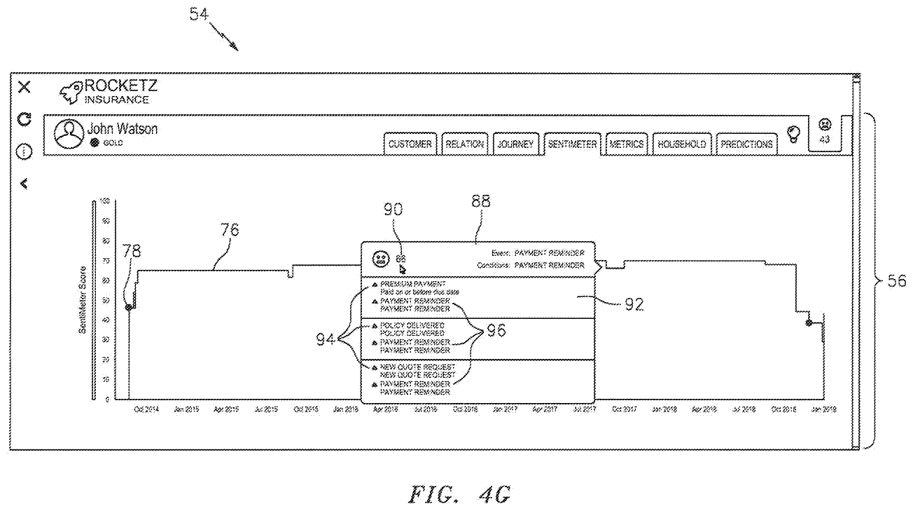

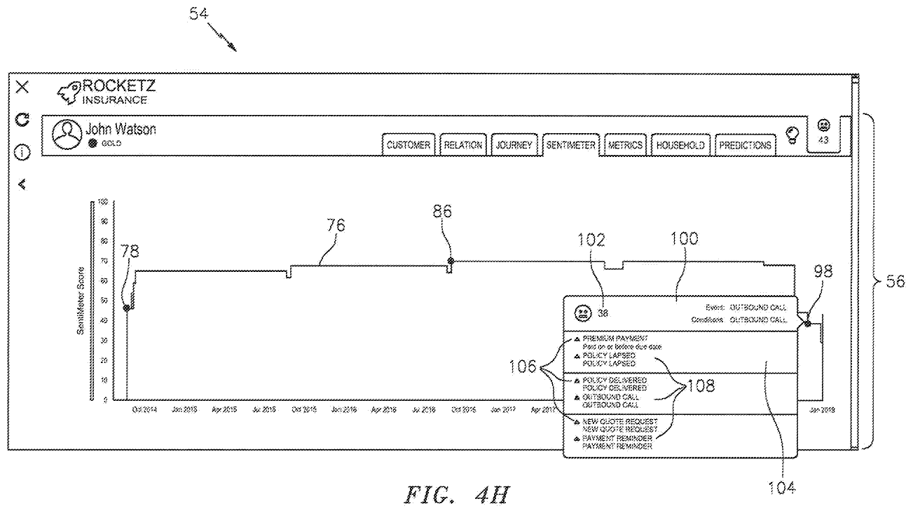

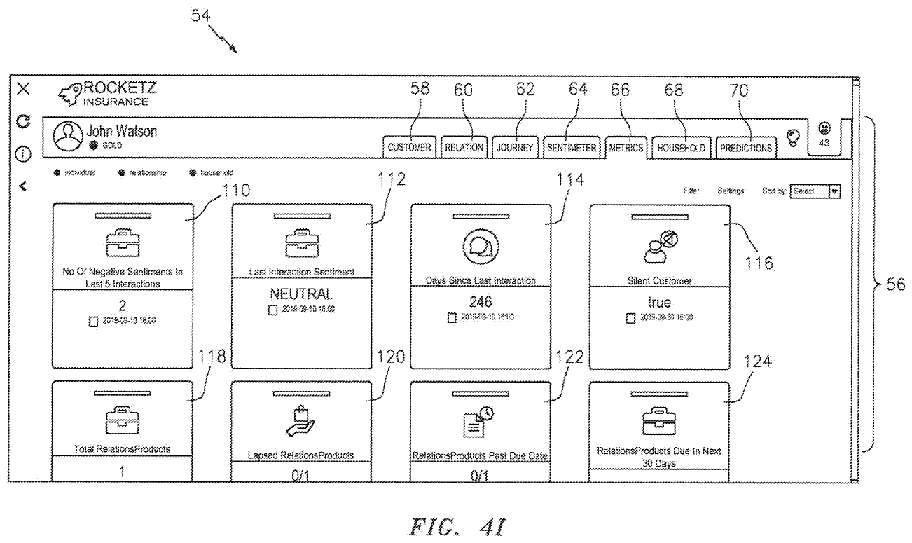

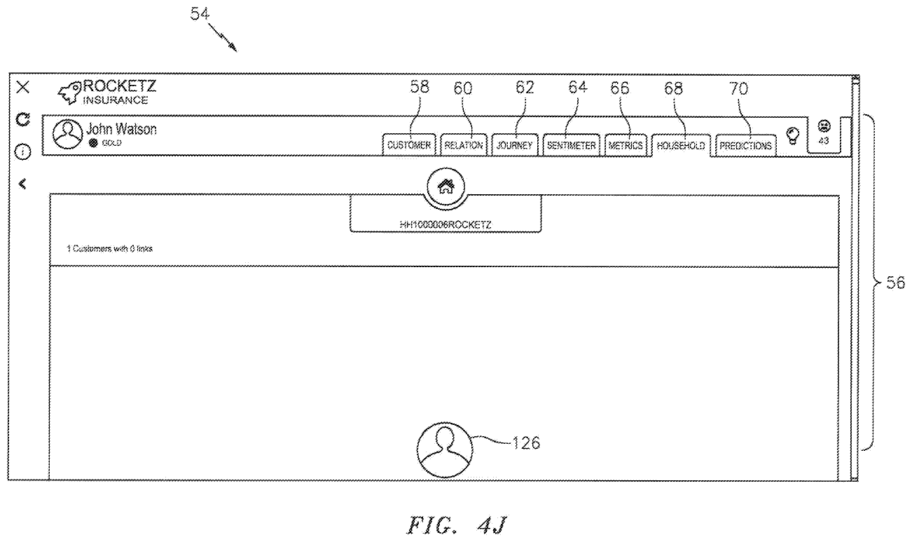

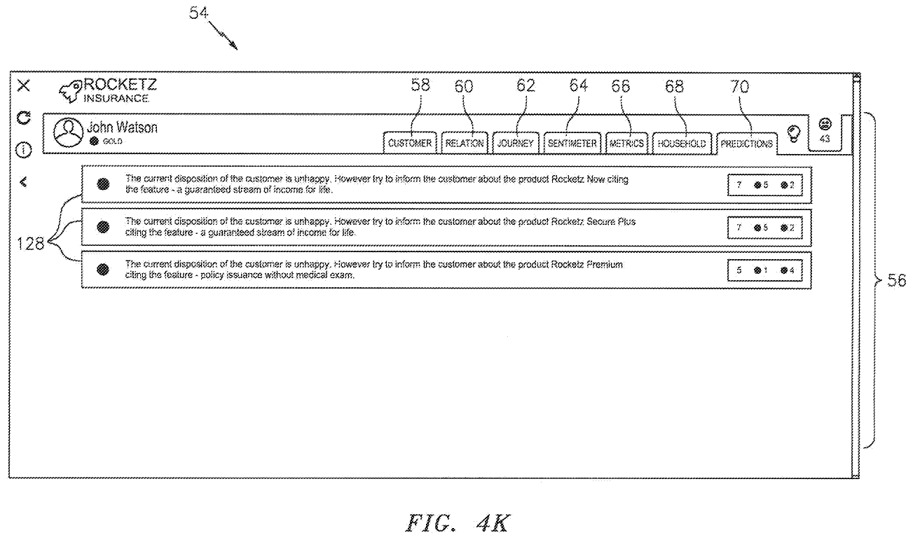

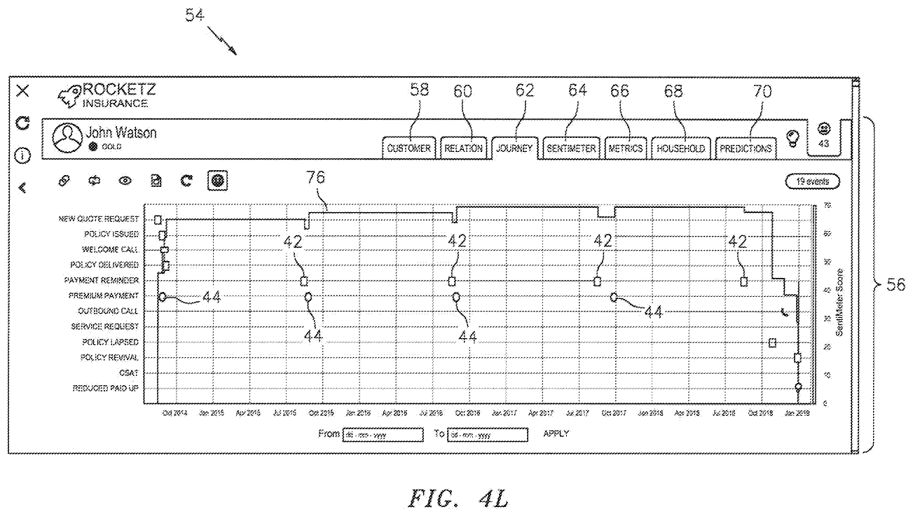

FIG. 1A shows a customer experience rating system (or CERS) 10 in accordance with embodiments of the present disclosure. The CERS 10 may comprise user device/computer 1000 operable by a client/user 1002. The device/computer 1000 is configured to output to a display 1004 viewable by the client/user 1002. The device/computer 1002 stores and/or is configured to execute a customer experience (CE) application 1006. The device/computer 1002 is configured to interface or communicate with a CE parameter server 1008 and a client/user attribute server 1010, which are configured to interface or communicate with a CE processor logic 1012. The CE processor logic 1012 comprises a CE calculation logic 1014, which interfaces or communicates with a weight calculation logic 1016. The CE calculation logic 1014 is configured to output data to a CE action logic 1018. Customer information data 1020 (e.g. received from a customer information data server) and/or customer interaction data 1022 (e.g. received from a customer interaction data server) are configured to be input into the CE processor logic 1012. Alerts 1024 are configured to be distributed from the user device/computer 1002 to the CE processor logic 1012 or from the CE processor logic 1012 to the device/computer 1002. For the purposes of this disclosure, when the CERS is configured to perform an action or function, one or more of the processors may be configured to perform the action or function. A customer experience score or value 14 (e.g. FIGS. 3 and 4E) can be individualized for a particular customer or a plurality of customers as is described in greater detail herein.

FIG. 1B shows the CERS 10 of FIG. 1A operating in a network environment. In particular, devices, computers, servers (collectively, “devices”) shown in FIG. 1B may be connected to or communicate with each other through the communications network 1026, which may be a local area network (LAN), wide area network (WAN), virtual private network (VPN), peer-to-peer network, or the internet, by sending and receiving digital data over the communications network. If the devices are connected via a local or private or secured network, the devices may have a separate network connection to the internet for use by device web browsers. The devices may also each have a web browser to connect to or communicate with the internet to obtain desired content in a standard client-server based configuration. Also, customer devices may communicate directly with the insurance company (or its network).

When operating in a network environment, the client/user 1002 operates the user device/computer 1000 connected to a network/internet 1026. The CE processing logic 1012, CE parameter server 1008, client/user attributes server 1010, customer information data server 1020 and customer interaction data server 1022 are connected to the network/internet 1026. Also connected to the network/internet 1026 are various elements of a company 1028 (e.g. insurance company 1028). The company 1028 is connected to the network/internet 1026 through various websites 1030, applications 1032 and/or call centers 1034. A plurality of customers 1036 are connected to the network/internet 1026 through a one or more customer devices 1038 through browsers/applications 1040.

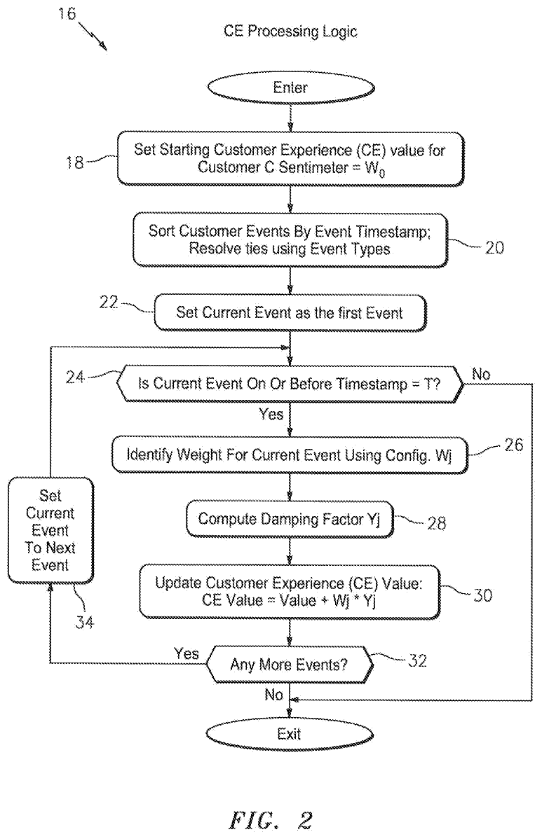

FIG. 2 shows a flow diagram 16 of a customer experience rating method in accordance with embodiments of the present disclosure. The CERS 10 of FIG. 1 may be configured to perform the method shown in FIG. 2 to generate the customer experience score 14. The method shown in FIG. 2 includes a plurality of customer interaction data 14 stored or input into the CERS 10. The method begins at block 18 where a starting customer experience value is set as the current customer experience value for each customer contained in the customer interaction data 14. Then at block 20, the CERS 10 sorts customer events by event timestamp in chronological order. Ties in event timestamp of events may be resolved by event type in accordance with a predetermined event type priority hierarchy. Then at block 22, the CERS 10 sets the current event as the first chronological event for processing (i.e. a starting event for processing). Then at block 24, the CERS 10 determines if the current event is on or before a timestamp T. If the current event is not on or before the timestamp T, the method proceeds to end. If the current event is on or before the timestamp T, the method proceeds to block 26. At block 26, the CERS 10 determines a weight for the current event using a weight configuration wⱼ. Then at block 28, the CERS 10 determines a damping factor yⱼ. Then at block 30, the CERS 10 determines an updated customer experience value (or cumulative customer experience value). In this embodiment, the updated customer experience value is equal to the starting customer experience value entered at block 18 plus the product of the weight configuration wⱼ and the damping factor yⱼ (i.e. updated customer experience value=(starting or current customer experience value)+(wⱼ*yᵢ)).

In some embodiments, the CERS 10 may determine the updated customer experience value or score (CES) based, at least in part, on a time decay factor and/or time between events. The time decay factor may, for example, adjust the starting or current customer experience value at block 30 based on the amount of time between the event being calculated for the updated customer experience value (or score) and the most recent prior event. For example and without limitation, a time decay factor dⱼ can be a reduction of 0.01 points in the CES for each day since the most recent prior event. However, any formula or relationship based on time may be used or set by an administrator or user of the CERS 10 for setting a time decay factor. Thus, if taking into account a time decay factor, the updated customer experience value is equal to the starting customer experience value entered at block 18, as adjusted by the time decay factor dⱼ, plus the product of the weight configuration wⱼ and the damping factor yⱼ. For example, in some embodiments, updated customer experience value=((starting or current customer experience value)*dⱼ)+(wⱼ*yᵢ); or updated customer experience value=(starting or current customer experience value−dⱼ)+(wⱼ*yᵢ)).

In some embodiments, the customer experience score (S or CES) for each customer “C” at time t may be computed as follows:

S(C,t)=S(C,t₁)×d(C,t−t₁)+yₜ×wₜ if there is an event at time t; or

S(C,t)=S(C,t₁)×d(C,t−t₁) if there is no event at time t;

where,
S(C, t₁) is the customer experience score (S or CES) right after the previous event for the customer, and t₁ is the time of occurrence of the previous event. If there is no previous event, t₁ is set equal to the starting time of the customer's timeline and wo is the starting value of the customer experience score;
yₜ is the damping factor described above and described in greater detail below;
wₜ is the weight of the event occurring at time t. The weight for a given event may be positive or negative and may vary based on the values of certain attributes of the event as is discussed in greater detail below; and
d(C, x) is the time decay factor, which may vary between zero (0) and one (1) and reduce with time; the time decay factor may be set to not reduce below a certain limit, or may also be set to vary from customer to customer.

The customer experience score (S or CES) calculation or equation may vary from the calculation and equations shown and described above, and may or may not include the time decay factor. Some examples of time decay factors are provided below:

Example 1: d(C, x)=max{1−x/700, 0.5}.
Example 2: d(C, x)=exp(−x/100).
Example 3: d(C, x)=1 In this case there is no time decay, and the customer experience score calculation collapses to a form without the time decay factor.
Example 4: d(C, x)=max {min{exp(−(x−100)/300), 1}, 0.5} In this case, the time decay factor is effective after x crosses one hundred (100), e.g. one hundred days (or other time interval/unit).
Example 5: d(C, x)=max {min{exp(−(x−Tc)/300), 1}, 0.4} In this case, the time decay factor is effective after an interval of time T_{c} which is derived from the customer's past history. For example, T_{c} may be set equal to the average time interval between two successive events for the customer in last 2 years.

The updated customer experience value is stored as the current customer experience value. Then at block 32, the CERS 10 determines if there are any more events for the customers. If there are more events, the method proceeds to block 34 where the current event as the next event. Then the method returns to block 24 to determine if the new current event is on or before timestamp T.

In some embodiments, the weight configuration wⱼ is determined based on the event type being evaluated. For example, a weight configuration wⱼ for a customer complaint 48 may have a greater weight than a service request 46. Weight configurations wⱼ may be predetermined for each event type in advance. In some embodiments, the weight configuration wⱼ may be determined based on a predetermined weight configuration table, relationship and/or equation. For example, a customer complaint 48 received shortly after one or more service requests 46 may have a greater weight configuration wⱼ than a customer complaint 48 without any recent, prior service requests 46. The weight configuration may be stored as a weight configuration table in the CERS 10, e.g., on the CE Parameter Server 1008 (FIG. 1A) or stored remote from the CERS 10 but accessible by the CERS 10.

In some embodiments, the damping factor yⱼ may be determined based on a predetermined relationship or equation. The damping factor may be determined so that the customer experience value or score does not exceed a predetermined threshold(s), or the predetermined methods for determining the damping factor are configured so that the customer experience value or score does not exceed the predetermined threshold(s). Further, the damping factor yⱼ may be calculated or determined differently for a positive event than as calculated or determined for a negative event. Furthermore, the damping factor yⱼ may be determined based on the current customer experience score or value 14 (or CES) and/or a maximum or minimum possible CES 14. For example, for a positive event, the damping factor yⱼ may calculated or determined as follows:

yⱼ=(maximum possible CES−current CES)/(100)

Similarly, for a negative event, the damping factor yⱼ may be calculated or determined as follows:

yⱼ=(current CES−minimum possible CES)/(100)

For example, in the case of a positive event where the maximum possible CES is one hundred (100) and the current CES is forty (40), the damping factor yⱼ=(100−40)/(100)=0.6. Similarly, in the case of a negative event where the minimum possible CES is zero (0) and the current CES is forty (40), the damping factor yⱼ=(40−0)/(100)=0.4. Accordingly, a positive event occurring in a customer's journey when the customer experience score 14 is closer to the minimum possible customer experience score will have a greater effect than a negative event. The opposite is true when the current customer experience score 14 is closer to the maximum possible customer experience score.

In some embodiments, the current customer experience value (updated at block 30) is equal to the customer experience score 14 (i.e. a 1:1 relationship). In some embodiments, the customer experience score 14 is determined (or calculated) based on the current customer experience value. For example, the customer experience score 14 might be more or less than the current customer experience value or even translated to different units and/or metrics than the value used for the current customer experience value. There are virtually any number of predetermined translation equations for converting a current customer experience value to a customer experience score 14. For simplicity for the purposes of the present disclosure, the current customer experience value is a number in the range of 0-100 and is equal to the customer experience score 14 on a 1:1 basis.

In some embodiments, the timestamp T is the current date and time at the time of the CERS 10 performing the method. In some embodiments, the timestamp T can be selectively chosen as a previous date and time by a user of the CERS 10. Accordingly, a customer experience score 14 generated when timestamp T is the current date and time can be considered a real-time cumulative customer experience score. The customer experience score 14 generated when timestamp T is selectively chosen as a previous date and time can be considered a prior customer experience value, which may be beneficial for studying customer experience changes in reflection of event history of a business or organization.

FIG. 3 shows a graphical user interface (or GUI) 36 of a CERS 10 in accordance with some embodiments of the present disclosure. In the GUI 36, a graph 38 provides an illustration of customer interaction data 12 and customer experience score 14. The graph 38 includes a plurality of events along the y-axis plotted against time on the x-axis. The events comprise policy issue 40, payment reminder 42, payment 44, service request 46, complaint 48 and policy canceled 50. However, any number or combination of events are within the scope of the present disclosure. For example, events may comprise a new quote request, prospect discovery, quote, welcome call, outbound call, application download, interaction (e.g. application interaction, web interaction or social media interaction), campaign response, renewal reminder, renewal quote, event of loss, claim intimation, claim document submission, inspection start, inspection end, claim approved, claim settled, claim rejected, claim closure, new car added, new driver added, telematics data, policy lapsed, policy revival, reduced paid up, credit score, customer experience survey, etc.

The customer experience score 14 is shown in the GUI 36 and includes a graphical indicator 52D representative of the relative position of the customer experience score 14 in the range of possible customer experience scores. Different graphical indicators may be predetermined based on different ranges of possible customer experience scores. In this embodiment there is a graphical indicator 52A for the range 0-9, graphical indicator 52B for the range 10-19, graphical indicator 52C for the range 20-29, graphical indicator 52D for the range 30-39, graphical indicator 52E for the range 40-49, graphical indicator 52F for the range 50-59, graphical indicator 52G for the range 60-69, graphical indicator 52H for the range 70-79, graphical indicator 521 for the range 80-89, graphical indicator 52J for the range 90-99, graphical indicator 52K for the value 100. Different applications may have different types and/or numbers of graphical indicators (or icons) for more or less ranges or values. In the GUI 36 shown in FIG. 3, the customer experience score 14 is a “36”. In this embodiment, a score of “36” in a range of 0-100 may be considered less than satisfactory. However, the corresponding level of experience with a customer experience score 14 may vary depending on the type of business, application, typical industry experience levels, and the like.

Referring to FIG. 4A, a GUI 54 of CERS 10 is shown in accordance with some embodiments of the present disclosure. The GUI 54 includes several tabs that, when selected, cause the CERS 10 to display corresponding information in a display field 56. The tabs includes a customer tab 58, a relation tab 60, a journey tab 62, a Sentimeter™ tab (or sentiment meter tab) 64, a metrics tab 66, a household tab 68 and a predictions tab 70.

In FIG. 4A, the customer tab 58 is selected and, thus, the display field 56 is displaying information related to a particular customer, in this case John Watson. Information related to a particular customer may include any number of information fields as may be set by an administrator of the CERS 10. For example, the customer information may include person details such as date of birth, marital status, age, correspondence address, email address and/or phone number(s). The customer information may further include official details such as a customer identification number unique to the customer, a household identification unique to a household that includes the customer, communication preference, automotive vehicle type, device type and/or shopping type preference. The customer information can include virtually any amount or combination of information fields such as marital status, hobbies, employment type, etc.

Referring to FIG. 4B, the GUI 54 is shown with the relation tab 60 is selected and, thus, the display field 56 is displaying relation information of the customer. Relation information of the customer may include any type of relationship information the customer has with the business administering the CERS 10. For example, relation information may include insurance policy information 72 that the customer has purchased from the business. The insurance policy information 72 may include any relevant information such as next due date for payment, the payment mode, the premium range, product (or policy) name, product (or policy) type, relationship identification number unique to the policy (or product) number, the agency name and agency branch that provided the insurance policy (or product) to the customer. The relation information may also include a customer experience score (CES) in connection with the product or policy.

Referring to FIGS. 4C and 4D, the GUI 54 is shown with the journey tab 62 selected and, thus, the display field 56 is displaying journey information of the customer. Journey information may plot customer interaction data in a graph similar to the graph 38 discussed above in connection with FIG. 3. In this embodiment, the customer interaction data is configured to be selected to provide further information. For example, when the payment reminder 42 is selected, further information about the payment reminder 42 is shown in the display field 56 in a pop-up window 74. The further information about the payment reminder 42 may include, for example, event date, event type, relationship identification number, sentiment impact, frequency, issue date, next due date, payment mode, premium amount, product name, current status and/or product type.

Referring to FIGS. 4E, 4F, 4G and 4H, the GUI 54 is shown with the Sentimeter™ tab 64 is selected and, thus, the display field 56 is displaying a customer experience score (CES) 14 of the customer in a graph 76 over time. The graph 76 is configured to be selected at different points in time to provide further information about the customer experience score and/or customer interaction data at that time (and/or cumulative to that time). For example, when a first point 78 is selected on the graph 76, further information about the customer experience score is shown in a pop-up window 80. A customer experience score 82 is shown indicative of the customer experience score of the customer at the time at the first point 78. The further information also includes a field 84 for showing the most impactful positive events and/or negative events. In FIG. 4F, since the graph 76 began at the first point 78, the only event in the field 84 is a new quote request event.

When a second point 86 is selected on the graph 76, further information about the customer experience score is shown in a pop-up window 88. A customer experience score 90 indicative of the customer experience score at the time of the second point 86 is shown in the pop-up window 88. Further, in the field 92, three of the most impactful positive events 94 (or top positive influencers) and three of the most impactful negative events 96 (or top negative influencers) are shown. While three of the most impactful positive events 94 and three of the most impactful negative events 96 are shown, it should be readily understood that the CERS 10 may be configured to record and display any number of positive events 94 and/or negative events 96 as predetermined or desired. Further, the number of events does not need to be the same. For example, three of the most impactful positive events 94 may be displayed while only two of the most impactful negative events 96 are displayed.

When a third point 98 is selected on the graph 76, further information about the customer experience score is shown in a pop-up window 100. A customer experience score 102 indicative of the customer experience score at the time of the third point 98 is shown in the pop-up window 100. Further, in the field 104, three of the most impactful positive events 106 and three of the most impactful negative events 108 are shown.

Finally, at a fourth point 99 and final point in the graph 76, the graph 76 corresponds to the current customer experience 14 of forty three (43). A corresponding graphical indicator 52D is representative of the customer experience score 14 being forty three (43). From the first point 78 to the fourth point 99 in the graph 76, the customer experience score 14 is visually plotted over time for a user of the CERS 10 to observe and evaluate. The positive and negative events moved the customer experience score 14. Advantageously, plotting the customer experience score 14 over time in the graph 76 allows the user to easily determine whether the customer arrived at the current customer experience score 14 in a downward trend or an upward trend. In this case, the customer arrived at the current customer experience score 14 of forty three (43) in a generally downward trend. Accordingly, the CERS 10 may be configured to indicate to a user that this customer requires more attention or different handling than a customer that arrived at the same or similar score in an upward trend (e.g. a customer that arrived at the score of forty three (43) from a previous score of twenty one (21)).

Referring to FIG. 4I, the GUI 54 is shown with the metrics tab 66 selected and, thus, the display field 56 is displaying information corresponding to metrics for the customer. Metrics information for the customer may include number of negative sentiments in the last 5 interactions 110, the last interaction sentiment 112, number of days since last interaction 114, whether the customer is a silent customer 116, the total number of relationship products purchased by the customer (or attributed to the customer) 118, the number of lapsed relationship products purchased by the customer (or attributed to the customer) 120, the number of relationship products with a past due date 122 and/or the number of relationship products due in the next thirty days (or other number of days/months/years) 124. The total number of loans to the customer may also be displayed or included in the metrics tab 66 display field 56.

Referring to FIG. 4J, the GUI 54 is shown with the household tab 68 selected and, thus, the display field 56 is displaying information corresponding to household information of the customer. In this embodiment, the household 126 of the customer John Watson consists of only John Watson. Where customers have additional household members that are also customers (and/or beneficiaries of business of products), then those members may be shown in the display field 56 when the household tab 68 is selected. Such members may be configured to be selected by a user of the CERS 10 in order to view information corresponding to that customer.

Referring to FIG. 4K, the GUI 54 is shown with the predictions tab 70 selected and, thus, the display field 56 is displaying information corresponding to prediction results 128 of the CERS 10 based on customer data, event data and/or the customer experience score of the customer. In this embodiment, the prediction results 128 includes an indication that the customer is unhappy, and offers the proposed potential actions of: (i) try to inform the customer about the product Rockets Now citing the feature—a guaranteed stream of income for life; (ii) try to inform the customer about the product Rocketz Secure Plus citing the feature—a guaranteed income stream for life; and (iii) try to inform the customer about the product Rocketz Premium citing the feature—policy issuance without medical exam. Any number or kind of potential actions may be included in the prediction results 128 and may be configured by the company or administrator of the CERS 10. For example, the prediction results 128 may include a particular method of contact with the customer, such as a telephone call instead of a email contact. A user of the CERS 10 may choose to initiate certain action(s) based on the prediction results 128 contained in the predictions tab 70 of the CERS 10.

Also, the dots (or bullets) on the screen associated with each of the predictions 128 may be colored, e.g., green or red, to provide a visual indication of a positive (green) or negative (red) prediction for this customer at a given time. In particular, the overall larger dot (or bullet) on left side of each of the predictions 128 may be indicative of a positive or negative prediction for this customer at a given point in time. In the top prediction example shown, the customer is deemed “unhappy” as his score is a 43 (shown in upper right of screen), but the large prediction dot would be positive (green) and provide suggestions for doing something to improve the customer experience score (CES). In general, a customer experience score of 0-60 may be deemed as “unhappy”, 61-80 may be “passive/neutral”, and 81-100 may be “happy”. Other score ranges may be used for the categories if desired. For each of the predictions 128, there may be a details/drill-down box to the right showing how many factors influenced that prediction, e.g., showing a total number of factors (on left side of box) followed by a break-down of how many positive and negative factors, next to small colored dots (e.g., green and red, left to right). For example, for the first (top) prediction 128, there were a total of 7 influencing factors or reasons associated with the customer journey (which may be weighted) used to make a positive prediction, 5 positive factors (green), and 2 negative factors (red), resulting in an overall result of a positive prediction. A similar breakdown is shown for the second and third predictions 128. In the third prediction, while there may have only been one positive factor and four negative factors, the one positive factor had more weight than the negative factors, resulting in an overall positive prediction (green large dot). In the event of a negative prediction, the large dot on the left side would be red, indicating something negative is likely to happen with this customer, e.g., the customer is not likely to renew his/her policy.

Referring to FIG. 4L, in some embodiments the GUI 54 is configured to include information from two or more tabs in the display field 56. In FIG. 4L, journey tab 62 is selected and is showing customer interaction data in the form of events and the graph 76 that is found in the Sentimeter™ tab 64 as discussed above. The ability to view the information of two or more tabs in a single display field 56 view allows a user of the CERS 10 to advantageously view customer interaction data in a manner that provides useful insights. In FIG. 4L, the graph 76 of the customer experience score can be seen to coincide events plotted over time from the journey tab 62.

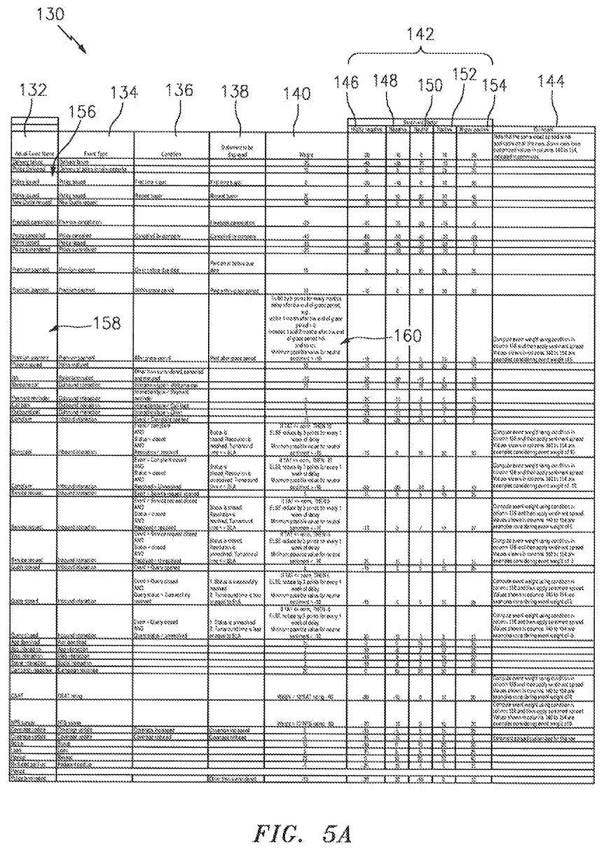

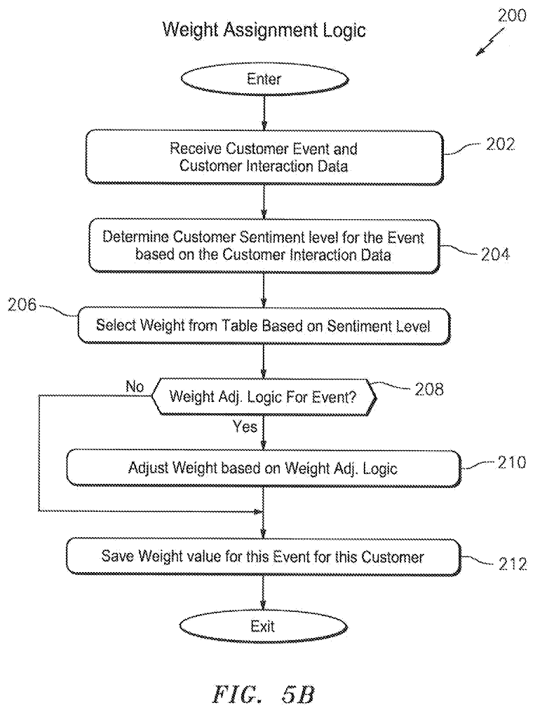

Referring to FIG. 5A, a weight configuration table 130 is shown in accordance with embodiments of the present disclosure. The weight configuration table 130 comprises weight information that may be used to determine the weight configuration wⱼ for each event as discussed above in connection with FIG. 2. The weight configuration table 130 includes an actual event name column 132, an event type column 134, a condition column 136, a statement to be displayed column 138, a weight column 140, a sentiment factor section 142, and a comment column 144.

The actual event name column 132 stores the event names for each event that may be visible to a user of the CERS 10 in one or more of the GUIs disclosed herein. The event type column 134 stores the categories for each event. The condition column 136 stores a condition of the event, e.g. for a “premium payment” event, there may be a condition of on or before grace period and a separate condition for after grace period depending on how and/or when the event is generated. The statement to be displayed column 138 stores information to be displayed to the user, for example, if the event is selected.

The weight column 140 stores the weight for each event type. Positive events in the weight column 140 have positive weights and negative events in the weight column 140 have negative weights. The weights stored in the weight column 140 may be more than one. For example, in the sentiment section factor section 142, different weights are assigned to different sentiment factors. In the sentiment factor section 142, there are five columns providing different weights for different sentiments: a highly negative sentiment column 146, a negative sentiment column 148, a neutral sentiment column 150, a positive sentiment column 152, and a highly positive sentiment column 154. When the customer interaction data 12 (FIG. 1) is provided to the CERS 10, each event may (or may not) include a sentiment marker. The sentiment marker indicates which sentiment column in the sentiment factor section 142 to be applied, and the weight wⱼ is assigned accordingly. For example, for the “policy issued” event 156 of the event type column 134 with a “first time buyer” condition 136, the weights for the different sentiment columns are provided as follows: −20 (highly negative), −10 (negative), 0 (neutral), 10 (positive), and 20 (highly positive). It should be readily understood that any weight distribution across the sentiment factor section 142 is within the scope of the present application. Further, weight distribution does not necessarily increase or decrease uniformly across all sentiment columns.

In addition or in alternative to the weights of a given event varying in accordance with a sentiment marker, weights of a given event may vary in accordance with a predetermined relationship, equation, or logic for a particular event. For example, for the “premium payment” event 158 of the event type column 134 with a “after grace period” condition 136, the weight wⱼ is varied in accordance with a predetermined logic 160. In the FIG. 5A embodiment, the logic 160 requires that the weight fall by five (5) points for every month's delay after the end of the grace period, with a minimum possible value for neutral sentiment column 150 of negative ten (−10). Virtually any mathematical expression may be used to be stored as a logic for varying the weight of an event. For example, the logic may consider a turnaround time (or TAT) for different actions, such as the TAT for a subsequent event following an event (e.g. the TAT for a premium payment following a payment reminder). The logic for each event may be predetermined by an administrator or user of the CERS 10.

Referring to FIG. 5B, a flow diagram 200 for a weight assignment logic method is shown. The CERS 10 may be configured to perform the method shown in FIG. 5B to determine a particular weight (e.g. for determining a weight at block 26 in FIG. 2 discussed above). The method shown in FIG. 5B includes, at block 202, receiving customer event data and/or customer interaction data. Then at block 204, the CERS 10 determines customer sentiment level for the event based on the customer interaction data. Then at block 206, the CERS 10 selects a weight from a weight configuration table (e.g., the weight configuration table 130 of FIG. 5A). Then at block 208, the CERS 10 determines whether there is weight adjustment logic for the event, e.g., the field 160 in the weight configuration table 130 (FIG. 5A). If yes, the method proceeds to block 210 and adjusts the weight based on the weight adjustment logic. If there is no weight adjustment logic for the event, the method skips block 210 and proceeds to block 212. At block 212, the CERS 10 saves the weight value for the event for the customer. In some embodiments, the logic may use machine learning to determine or optimize the weight value for a given event or customer or insurance policy.

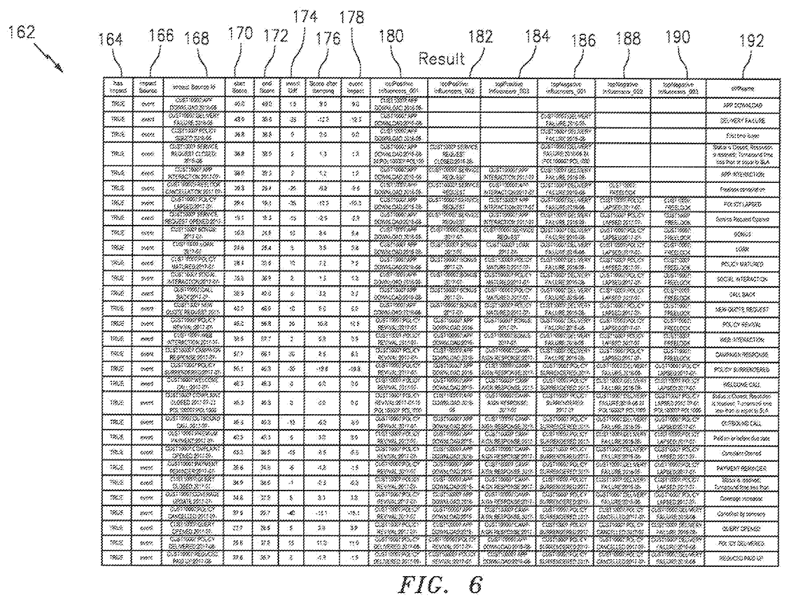

Referring to FIG. 6, an output (or results) table 162 of a CERS 10 is shown in accordance with embodiments of the present disclosure. The output table 162 provides a chronological audit history in table form for a particular customer. The output table 162 comprises a has impact column 164, an impact source column 166, an impact source identification column 168, a start score column 170, an end score column 172, an event score differential column 174, an after-damping event score differential column 176, an event impact column 178, a first top positive influencer column 180, a second top positive influencer column 182, a third top positive influencer column 184, a first top negative influencer column 186, a second top negative influencer column 188, a third top negative influencer column 190, and an event differential name (or event name) column 192.

Each row of the output table 162 corresponds to an event listed in the impact source identification column 168 where each unique event recorded in the calculation of the customer experience score 14 is provided. The start score column 170 contains the starting customer experience score 14 of the customer prior to the score 14 being calculated after the event for that row. The end score column 172 contains the end customer experience score 14 after calculation as disclosed herein. The event score differential column 174 contains the weight wⱼ value prior to damping. The after-damping event score differential column 176 contains the event score after damping. The output or results table may be stored on the CE Parameter Server 1008 (FIG. 1A) or other storage medium accessible by the logic.

The first top positive influencer column 180 contains the impact source identifier (e.g. column 168) of the event that had the largest positive event score differential after-damping (e.g. column 176) to date of the particular event. The second top positive influencer column 182 contains the impact source identifier (e.g. column 168) of the event that had the second largest positive event score differential after-damping (e.g. column 176) to date of the particular event. The third top positive influencer column 184 contains the impact source identifier (e.g. column 168) of the event that had the third largest positive event score differential after-damping (e.g. column 176) to date of the particular event. The first top negative influencer column 186 contains the impact source identifier (e.g. column 168) of the event that had the largest negative event score differential after-damping (e.g. column 176) to date of the particular event. The second top negative influencer column 188 contains the impact source identifier (e.g. column 168) of the event that had the second largest negative event score differential after-damping (e.g. column 176) to date of the particular event. The third top negative influencer column 190 contains the impact source identifier (e.g. column 168) of the event that had the third largest negative event score differential after-damping (e.g. column 176) to date of the particular event. As discussed herein, there may be any number of top positive or negative influencers to be stored by the CERS 10 and/or displayed to a user of the CERS 10.

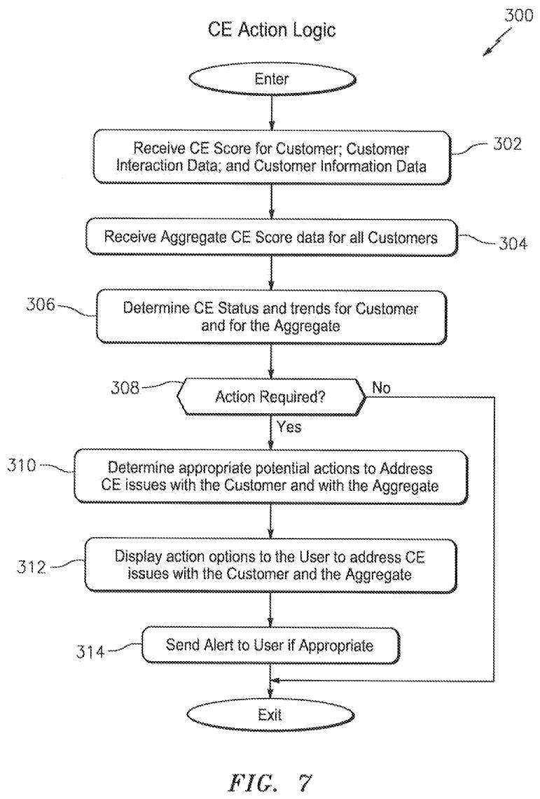

Referring to FIG. 7, a flow diagram 300 for a CE action logic is shown in accordance with embodiments of the present disclosure. The method begins at block 302 where a CE score for customer, customer interaction data and customer information data is received by the CERS 10. Then at block 304, the CERS 10 receives aggregate CE score data for all customers (or at least a plurality of customers), i.e. the Aggregate. Then at block 306, the CERS 10 determines CE status and trends for customer and for the Aggregate. Then at block 308, the CERS 10 determines whether action is required. If no action is required, the method proceeds to exit the CE action logic process. If action is determined to be required, then the method proceeds to block 310, where the CERS 10 determines appropriate potential actions to address CE issues with the customer and the Aggregate. Potential actions may be configured by the company or administrator. For example, potential actions may be actions such as the actions shown and described above in connection with FIG. 4K. Then at block 312, the CERS 10 displays action options to the client/user (e.g. 1002 of FIGS. 1A and 1B) to address CE issues with the customer and the aggregate. Then at block 314, the CERS 10 sends an alert(s) to the client/user if appropriate. Then the process exits.

Advantageously, methods, systems and devices disclosed herein may use the damping factor to dampen score changes from abruptly reaching the maximum possible CES 14 or minimum possible CES 14 since the damping factor will operate to significantly dampen the differential event score when the current customer experience score 14 is relatively close to the maximum or minimum possible CES 14. Further, the dampening factor make different tiers of customer experience scores 14 more meaningful for business purposes. For example, if the business wanted to initiate a campaign to target certain customers in a tier, e.g. in the score range of 80-90, the customer variation from customers in a different tier, e.g. in the score range of 90-95, may be significant enough to provide information to a user of the CERS 10 to provide focused efforts in campaigns or other business decisions.

Also, the CE score may be calculated for an individual customer across all insurance policies or products used by the customer, or the CE score may be calculated for each policy held by the customer, e.g., a “policy level” CE score. In that case, the policy CE scores may be aggregated and tiered for analysis, business decisions and action as needed, as described above. In addition, the CE score may be calculated for an individual customer for various stages of a customer journey, e.g., on-boarding, claim handling, policy renewal, and the like, which may be called a “journey” CE score. In that case, the journey CE scores may be aggregated and tiered for analysis, business decisions and action as needed, as described above

In some embodiments, the CERS 10 may monitor, record and indicate from which direction a customer entered a particular customer experience score 14 tier. In other words, the CERS 10 may be configured to provide “trending” information of the customer. For example, if the customer experience score is currently sixty (60), but the customer recently was assigned a score of eighty (80), then the customer is trending down from a higher tier. Conversely, if the customer experience score is currently sixty (60), but the customer recently was assigned a score of forty (40), then the customer is trending up from a lower tier. The rate and/or magnitude of trending information may be provided to a user of the CERS 10 for more rich data sets.

The customer events may be received and stored from many different aspects of a business. For example, and without limitation, events may be received from point of sale interactions, policy issuance interactions (including renewal interactions), billing interactions, customer service interactions, claims department interactions, social media interactions, email interactions, survey interactions, and virtually any other possible interactions between the customers and the business, affiliates of the business or other entities. For example, complaints do not need to be lodged directly with the business. In the situation where a customer provides negative comments on a social media platform about the business, the business may identify those comments and generate a complaint customer event type for that customer.

In some embodiments, the customer experience score 14 (e.g. FIG. 1) may be relied on to alter business operations. For example, when a business decides to start a new campaign (or proceed with an ongoing campaign), the business can make strategic decisions based on the plurality of customer experience scores. In some embodiments, the customer experience rating system is configured to generate different customer lists or mailing lists depending on the campaign and customer experience scores. For example, if a campaign mailing is scheduled to be delivered, customers having a experience score below a predetermined threshold may be removed from the list in an effort to not further dissatisfy those customers and/or lower their customer experience score.

Additionally, the systems and methods disclosed herein may provide improved net promoter score, increased retention, improve cross-sell and up-sell opportunities, predict early claims, and/or predict fraud. The systems and methods disclosed herein may be used by, for example and without limitation, insurance carriers, brokers, insurance agents, independent agents, managing general agents, and banks. Artificial intelligence may power analytic solutions for business users, which rely on the customer experience scores disclosed herein.

Advantageously, in some embodiments, devices, systems and methods are configured to generate a real-time experience score output that may help identify the current disposition or happiness factor of one or more customers which may help the business to make strategic decisions on how to improve the customer experience significantly. The experience score may also help in identifying key influencers which drives the customer experience or sentiment. A experience monitor or meter (or sentiment monitor or meter) provides strategic inputs at least at different levels. For example, at an aggregate level, an individual customer level, and/or at an organizational unit level. At an aggregate level, the experience monitor may provide segmentation and micro segmentation variables which help in creating target groups of customers for actionables. At an individual customer level, it may provide a score and pointer that influences the score which can be used to fine tune interaction strategy with the individual customer. At an organizational unit level, it may help in comparing performance and analyzing where the unit lacks/excels.

Advantageously, systems, devices and methods according to embodiments of the present disclosure may be used to determine or estimate customer experience of a plurality of customers of an insurance company. An insurance company can utilize the customer experience score to alter business operations as disclosed herein. For instance, an insurance company could decide how and when to approach the customers for potential cross-sell and/or up-sell opportunities depending on each customer's experience score.

Advantageously, systems, devices and methods according to embodiments of the present disclosure may provide an industry-specific score that is calculated in real-time based on the data provided by the company (e.g. insurer) from their internal systems. Data may provide as structured and/or unstructured data and applied using artificial intelligence and machine learning to extract customer sentiment in order to build the score. Hence, it may improve in accuracy as more data is processed over time. While the disclosure has been described in some embodiments herein with regard to events and a journey of a customer associated with or interacting with an insurance company, the present disclosure may be used with and applied to any customer interactions with any company in any industry.

Advantageously, systems and methods according to the present disclosure can provide an accurate and detailed customer experience score for a plurality of customers. The customer experiences scores capable of being achieved by the systems and methods according to the present disclosure may be more accurate than traditional outbound customer surveys which may have inherent sample bias.

The system, computers, devices and the like described herein have the necessary electronics, computer processing power, interfaces, memory, hardware, software, firmware, logic/state machines, databases, microprocessors, communication links, displays or other visual or audio interfaces, printing devices, and any other input/output interfaces, to provide the functions or achieve the results described herein. Except as otherwise explicitly or implicitly indicated herein, process or method steps described herein may be implemented within software modules (or other computer programs) executed on one or more general purpose computers. Specially designed hardware may alternatively be used to perform certain operations. Accordingly, any of the methods described herein may be performed by hardware, software, or any combination of these approaches. In addition, a computer-readable storage medium may store thereon instructions that when executed by a machine (such as a computer) result in performance according to any of the embodiments described herein.

Any process descriptions, steps, or blocks in process or logic flow diagrams provided herein indicate one potential implementation, do not imply a fixed order, and alternate implementations are included within the scope of the present disclosure in which functions or steps may be deleted or performed out of order from that shown or described, including substantially concurrently or in reverse order, depending on the functionality involved, as would be understood by those reasonably skilled in the art.

Conditional language, such as, among others, “can,” “could,” “might,” or “may,” unless specifically stated otherwise, or otherwise understood within the context as used, is generally intended to convey that certain embodiments could include, but do not require, certain features, elements, or steps. Thus, such conditional language is not generally intended to imply that features, elements, or steps are in any way required for one or more embodiments or that one or more embodiments necessarily include logic for deciding, with or without user input or prompting, whether these features, elements, or steps are included or are to be performed in any particular embodiment.

Although exemplary embodiments of the present disclosure have been shown and described in detail, it will be understood by those skilled in the art that various changes in form and detail may be made without departing from the spirit and scope thereof

What is claimed is:

1. A customer experience rating system comprising:
a processor; and
a database storing weight configuration data;
wherein the processor is configured to receive customer interaction data; and
wherein the processor is configured to provide a customer experience score for each customer contained in the customer interaction data based on events identified in the customer interaction data and the weight configuration data.

2. The customer experience rating system according to claim 1, wherein the customer interaction data comprises a plurality of sentiment markers, each sentiment marker of the plurality of sentiment markers being associated with a unique event in the customer interaction data, and wherein the processor is configured to provide the customer experience score for each customer based further on the plurality of sentiment markers.

3. The customer experience rating system according to claim 1, wherein the processor is configured to provide the customer experience score for each customer based on a damping factor, and wherein the damping factor prevents the customer experience score from exceeding a maximum possible score or a minimum possible score.

4. The customer experience rating system according to claim 3, wherein the damping factor is determined based on the maximum possible score or the minimum possible score.

5. The customer experience rating system according to claim 1, wherein processor is configured to provide the customer experience score using a time based decay factor which adjusts the customer experience score calculated at the most recent prior event such that the contribution of the most recent event is applied to a time adjusted value of the most recent customer experience score.

6. The customer experience rating system according to claim 1, wherein the processor is configured to provide the customer experience score based on, at least in part, time between the events.

7. The customer experience rating system according to claim 1, wherein the processor is configured to provide a graphical user interface to a display, and wherein the graphical user interface shows a graph of the customer experience score plotted over time.

8. The customer experience rating system according to claim 7, wherein the processor is configured to receive an input from a user selecting a point of the graph, and wherein the graphical user interface shows one or more events of the events that is most impactful positively on the customer experience score to date at the time of the point of the graph and/or the graphical user interface shows one or more events of the events that is most impactful negatively on the customer experience score to date at the time of the point of the graph.

9. The customer experience rating system according to claim 1, wherein the processor is configured to provide a graphical user interface to a display, wherein the graphical user interface shows symbols plotted over time, and wherein each symbol is indicative of one event of the events.

10. The customer experience rating system according to claim 9, wherein the events comprise at least one of: policy issue, payment reminder, payment, service request, complaint, and policy canceled.

11. The customer experience rating system according to claim 1, wherein the processor is configured to provide a graphical user interface to a display, wherein the graphical user interface shows a graphical symbol indicative of a relative position of the customer experience score in a range of possible customer experience scores.

12. The customer experience rating system according to claim 1, wherein the processor is configured to provide a graphical user interface to a display, wherein the graphical user interface shows a metrics data for a customer of the customer interaction data, and wherein the metrics data comprises at least one of a number of negative sentiments, a number of days since last interaction, a number of products purchased by the customer, a number of lapsed products purchased by the customer, a number of products coming due for the customer, and a number of loans to the customer.

13. The customer experience rating system according to claim 1, wherein the processor is configured to update the customer experience score for each respective customer following each event after a first event of the events according to the following formula:
updated CES=(current CES)+(Wⱼ*Yⱼ);
where the updated CES is the updated customer experience score, the current CES is a current customer experience score, the Wⱼ is a weight configuration from the weight configuration table corresponding to the respective event being considered for the updated customer experience score, and the Yⱼ is a damping factor having a value that keeps the updated CES within a predetermined range.

14. The customer experience rating system according to claim 13, wherein, if the event positively contributes to the customer experience score, the damping factor=(a maximum possible score−the current customer experience score)/100, and wherein, if the event negatively contributes to the customer experience score, the damping factor=(the current customer experience score−a minimum possible score)/100.

15. A method of determining a customer experience score comprising:
receiving customer interaction data indicative of customer interaction events with a service provider;
receiving weight configuration data indicative of a weight associated with the events in the customer interaction data;
calculating the customer experience score (CES) for each customer contained in the customer interaction data based on the events identified in the customer interaction data and the weight configuration data.

16. The method according to claim 15, the method further comprising updating the customer experience score for each respective customer following each event after a first event of the events according to the following formula:
updated CES=(current CES)+(Wⱼ*Yⱼ);
where the updated CES is the updated customer experience score, the current CES is a current customer experience score, the Wⱼ is a weight configuration from the weight configuration table corresponding to the respective event being considered for the updated customer experience score, and the Yⱼ is a damping factor having a value that keeps the current CES within a predetermined range.

17. The method according to claim 16, wherein the predetermined range is 0 to 100.

18. A method of operating a customer user experience rating system, the customer experience rating system comprising:
a processor; and
a database storing weight configuration data;
wherein the processor is configured to receive customer interaction data; and
the method comprising:
providing, by the processor, a customer experience score as an initial customer experience score for each customer contained in the customer interaction data;
receiving, by the processor, an event weight configuration for each event of the events corresponding to a type of the respective event identified in the customer interaction data;
updating, by the processor, the customer experience score for each customer contained in the customer interaction data based on the determined weight configuration for each respective event; and
providing, by the processor, the updated customer experience score for each customer contained in the customer interaction data.

19. The method according to claim 18, wherein the processor provides the updated customer experience score using a time based decay factor which adjusts the customer experience score calculated at the most recent prior event such that the contribution of the most recent event is applied to a time adjusted value of the most recent customer experience score.

20. The method according to claim 18, wherein the processor provides the updated customer experience score based, at least in part, on time between the events.
